(19) United States
(12) Patent Application Publication
(10) Pub. No.: US 2007/0149379 A1
(43) Pub. Date: Jun. 28, 2007

(54) Crystallizable glass and crystallized glass of Li2O-A12O3-SiO2 system and method for producing crystallized glass fo Li2O-A12O3-SiO2 system

(76) Inventors: Kuo-Chuan Hsu, Hsinchu County (TW); Gan-Cheng Zhang, Zhejiang (CN); Chien-Liang Tseng, Hsinchu County (TW); Zheng-Li Zhang, Zhejiang (CN)

Correspondence Address: MARTINE PENILLA & GENCARELLA, LLP, 710 LAKEWAY DRIVE, SUITE 200, SUNNYVALE, CA, 94085, US

(21) Appl. No.: 11/713,322

(22) Filed: Mar. 2, 2007

Related U.S. Application Data
(62) Division of application No. 11/122,891, filed on May 4, 2005.

(30) Foreign Application Priority Data
Jan. 20, 2005 (JP) JP2005-013077

(51) Int. Cl. C03C 10/14; C03C 10/12

(52) U.S. Cl. 501/7; 501/4

(57) ABSTRACT

A crystallizable glass of Li₂O—Al₂O₃—SiO₂ system is provided, which can be crystallized by a crystallization process at a lower temperature to produce crystallized glass of Li₂O-Al₂O₃—SiO₂ system with excellent thermal characteristics. The crystallizable glass of Li₂O—Al₂O₃—SiO₂ system which consists essentially of, by weight percentages, SiO₂—58.0˜66.0 wt %; Al₂O₃—18.0˜26.0 wt %; Li₂O—3.5˜5.5 wt %; TiO₂—0.5-4.0 wt %; ZrO₂—0.5˜3.0 wt % P₂O₅—0.5˜3.0 wt %; F—0.1˜1.0 wt %; B₂O₃—0˜2.5 wt %; Na₂O—0˜2.0 wt %; K₂O—0˜2.0 wt %; MgO—0˜1.0 wt %; ZnO—0.5˜3.0 wt %; BaO—0˜2.5 wt %; SrO—0.3˜3.0 wt % As₂O₃—0.4˜1.5 wt %; and Sb₂O₃—0˜1.5 wt %.

### CLAIM OF PRORITY

This application is a divisional application of U.S. application Ser. No. 11/122,891, filed on May 4, 2005, from which 35 USC §120 priority is claimed. This application is herein incorporated by reference.

### BACKGROUND OF THE INVENTION

(a) Field of the Invention

The present invention relates to crystallizable glass, transparent crystallized glass and non-transparent crystallized glass of Li₂O—Al₂O₃—SiO₂ system, more particularly, to a crystallizable glass of Li₂O—Al₂O₃—SiO₂ system, which can be crystallized by a crystallization process at lower temperature to produce transparent crystallized glass and non-transparent crystallized glass of Li₂O—Al₂O₃—SiO₂ system with excellent thermal characteristics.

(b) Description of the Related Art

In recent years, crystallized glass of Li₂O—Al₂O₃—SiO₂ system has been used as substrates for high-technology products such as color filters and image sensors, fire proof material for baking electronic devices, plates for electromagnetic cooking devices, optical parts, shelf boards for microwave ovens, plates for barbecue, window glass for fire doors, and front glass panels in kerosene heaters, wood stoves, and the like.

For example, Japanese Examined Patent Publication No. S39-21,049, Japanese Examined Patent Publication No. S40-20,182, Japanese Laid-open Patent Publication No. H1-308845, Japanese Laid-open Patent Publication No. 6-329439, Japanese Laid-open Patent Publication No. 9-188538, Japanese Laid-open Patent Publication No. 2001-48582, and Japanese Laid-open Patent Publication No. 2001-48583 have disclosed crystallized glass of Li₂O—Al₂O₃-nSiO₂ system in which a β-quartz solid solution (Li₂O—Al₂O₃-nSiO₂, n≧2) or a β-spodumene solid solution (Li₂O—Al₂O₃-nSiO₂, n≧4) is produced as a main crystal.

The crystallized glass of Li₂O—Al₂O₃—SiO₂ system mentioned above has superior thermal characteristics, such as a low coefficient of thermal expansion, and high mechanical strength.

In addition, after the raw glass material of the crystallized glass of Li₂O—Al₂O₃—SiO₂ system mentioned above is melted and molded, a crystallizable glass of Li₂O—Al₂O₃—SiO₂ system is obtained. Since the type of crystal produced in the crystallized glass of Li₂O—Al₂O₃—SiO₂ system is alterable by changing heating conditions in a crystallization process, transparent crystallized glass (a β-quartz solid solution is produced) and white and opaque crystallized glass (a β-spodumene solid solution is produced) can be produced from the same composition of raw glass materials. Consequently, one of the advantages is that the same composition of raw glass materials can be used to produce different crystallized glasses in accordance with the applications.

To produce the white and opaque crystallized glass (a β-spodumene solid solution is produced) of Li₂O—Al₂O₃—SiO₂ system in the past, the raw glass material is melted and molded, and then a crystallizable glass of Li₂O—Al₂O₃—SiO₂ system is obtained. After the nucleus of the crystallizable glass is formed, the crystallization process is executed by a thermal treatment. However, the temperature for crystallization is still required to be set at a high temperature of 1,000° C.˜1,300° C.

### BRIEF SUMMARY OF THE INVENTION

An object of the present invention is to provide crystallizable glass of 2O—Al₂O₃—SiO₂ system as a raw glass material of crystallized glass of Li₂O—Al₂O₃—SiO₂ system.

Another object of the present invention is to provide crystallized glass of Li₂O—Al₂O₃—SiO₂ system with excellent thermal characteristics and mechanical strength produced by crystallization of the crystallizable glass at a lower temperature range after the nucleus of the crystallizable glass is formed.

Another object of the present invention is to provide a method for producing crystallized glass of Li₂O—Al₂O₃—SiO₂ system with excellent thermal characteristics and mechanical strength by crystallizing the crystallizable glass in a lower temperature range after nucleus of the crystallizable glass is formed.

One other object of the present invention is to provide transparent and non-transparent crystallized glass of different colors.

According to one aspect of the present invention, there is provided crystallizable glass of Li₂O—Al₂O₃—SiO₂ system which consists essentially of, by weight percentages, SiO₂—58.0˜66.0 wt %; Al₂O₃—18.0˜26.0 wt %; Li₂O—3.5˜5.5 wt %; TiO₂—0.5˜4.0 wt % ; ZrO₂—0.5˜3.0 wt %; P₂O₅—0.5˜3.0 wt %; F—0.1—1.0 wt%; B₂O₃—0˜2.5 wt %; Na₂O—0˜2.0 wt %; K₂O—0˜2.0 wt %; MgO—0˜1.0 wt %; ZnO—0.5˜3.0 wt %; BaO—0˜2.5 wt %; SrO—0.3˜3.0 wt %; As₂O₃—0.4˜1.5 wt %; and Sb₂O₃—0˜1.5 wt %.

According to another aspect of the present invention, there is provided crystallized glass of Li₂O—Al₂O₃—SiO₂ system which consists essentially of, by weight percentages, SiO₂—58.0˜66.0 wt %; Al₂O₃—18.0˜26.0 wt %; Li₂O—3.5˜5.5 wt %; TiO₂—0.5˜4.0 wt %; ZrO₂—0.5˜3.0 wt %; P₂O₅—0.5˜3.0 wt %; F—0.1˜1.0 wt %; B₂O₃—0˜2.5 wt %; Na₂O—0˜2.0 wt %; K₂O—0˜2.0 wt %; MgO—0˜1.0 wt %; ZnO—0.5˜3.0 wt %; BaO—0˜2.5 wt %; SrO—0.3˜3.0 wt %; As₂O₃—0.4˜1.5 wt %; and Sb₂O₃—0˜1.5 wt %.

The crystallized glass of Li₂O—Al₂O₃—SiO₂ system may be transparent crystallized glass of Li₂O—Al₂O₃—SiO₂ system in which a β-quartz solid solution (Li₂O—Al₂O₃-nSiO₂, n≧2) is produced as a main crystal.

Or, the crystallized glass of Li₂O—Al₂O₃—SiO₂ system may be non-transparent crystallized glass of Li₂O—Al₂O₃—SiO₂ system in which a β-spodumene solid solution (Li₂O—Al₂O₃-nSiO₂, n≧4) is produced as a main crystal.

According to another aspect of the present invention, at least one transition element may be added to the glass, thereby forming colored crystallizable glass and colored crystallized glass of different colors. The transition element may be TiO₂, V₂O₅, Cr₂O₃, MnO₂, Fe₂O₃, Co₃O₄, Co₂O₃, NiO, or CuO.

### DETAILED DESCRIPTION OF THE INVENTION

Crystallizable glass of Li₂O—Al₂O₃—SiO₂ system and the method for producing the same, and crystallized glass of Li₂O—Al₂O₃—SiO₂ system and the method for producing the same in accordance with the present invention will hereinafter be described in detail.

In the present invention, crystallizable glass is glass obtained by melting and molding a raw glass material having certain compositions, and crystallized glass is glass obtained by treating the crystallizable glass with a crystallization process at a certain temperature.

The raw material of crystallizable glass and crystallized glass in accordance with the present invention composes, by weight percentages, SiO₂—58.0˜66.0 wt %; Al₂O₃—18.0˜26.0 wt %; Li₂O—3.5˜5.5 wt %; TiO₂—0.5˜4.0 wt %; ZrO₂—0.5˜3.0 wt %; P₂O₅—0.5˜3.0 wt %; F—0.1˜1.0 wt %; B₂O₃—0˜2.5 wt %; Na₂O—0˜2.0 wt %; K₂O—0˜2.0 wt %; MgO—0˜1.0 wt %; ZnO—0.5˜3.0 wt %; BaO—0˜2.5 wt %; SrO—0.3˜3.0 wt %; As₂O₃—0.4˜1.5 wt %; and Sb₂O₃—0˜1.5 wt %.

After the raw glass material having the composition mentioned above is melted and molded, a crystallizable glass of Li₂O—Al₂O₃—SiO₂ system is obtained.

Then, the crystallizable glass is crystallized and becomes transparent crystallized glass of Li₂O—Al₂O₃—SiO₂ system in which a β-quartz solid solution (Li₂O—Al₂O₃-nSiO₂, n≧2) is produced as a main crystal. In addition, the temperature of the crystallization process can be changed during crystallization of the crystallizable glass, performing the crystallization process at lower temperature, such that non-transparent crystallized glass of Li₂O—Al₂O₃—SiO₂ system in which a β-spodumene solid solution (Li₂O—Al₂O₃-nSiO₂, n≧4) is produced as a main crystal is formed.

Moreover, one or more transition element oxides may be added into the raw glass material. The transition element oxide may be TiO₂, V₂O₅, Cr₂O₃, MnO₂, Fe₂O₃, Co₂O₃, Co₃O₄, NiO, or CuO. The raw glass material containing the at least one transition element is melted and molded to form crystallizable glass, and then the crystallizable glass is crystallized by a crystallization process, where it becomes colored transparent crystallized glass of Li₂O—Al₂O₃—SiO₂ system in which a β-quartz solid solution (Li₂O—Al₂O₃-nSiO₂, n≧2) is produced as a main crystal. On the other hand, the temperature of the crystallization process can be changed during crystallization of the crystallizable glass, performing the crystallization process at lower temperature, such that colored non-transparent crystallized glass of Li₂O—Al₂O₃—SiO₂ system in which a β-spodumene solid solution (Li₂O—Al₂O₃-nSiO₂, n≧4) is produced as a main crystal is produced.

As mentioned above, after the crystallizable glass is obtain by melting and molding the raw glass material, the conditions of the crystallization process can be changed, whereby the crystal type can be altered. Accordingly, using the same composition of raw glass materials can produce the transparent and non-transparent crystallized glass mentioned above.

The transparent and non-transparent crystallized glass in accordance with the present invention obtained by using the manufacturing method mentioned above is processed by, for example, cutting, polishing, bending, painting thereon, and the like, and thus it may be used for different applications.

Next, each composition in the raw glass material of crystallizable glass and crystallized glass in accordance with the present invention will be described.

The content of SiO₂ according to the present invention, which is a main constituent for forming the crystal and the glass network former, is 58.0 to 66.0 wt %, and preferably, 63.0 to 65.0 wt %. When the content of SiO₂ is less than 58.0 wt %, the coefficient of thermal expansion is increased considerably. On the other hand, when the content thereof is more than 66.0%, the melting temperature of the glass becomes too high.

Al₂O₃ is a main constituent for forming the crystal and the glass network former. The content of Al₂O₃ according to the present invention is 18.0 to 26.0 wt%, and preferably, 21.0 to 23.0 wt %. When the content of Al₂O₃ is less than 18.0 wt %, the chemical resistance of crystallizable glass and crystallized glass obtained therefrom is deteriorated, and the glass is likely to devitrify. On the other hand, when the content thereof is more than 26.0 wt %, the glass is difficult to melt due to the viscosity thereof being too high.

Li₂O is a component for constituting the crystal and has a function of decreasing the viscosity thereof in addition to a significant influence on the crystallinity of the glass. The content of Li₂O is 3.5 to 5.5 wt %, and preferably, 3.7 to 4.2 wt %. When the content of Li₂O is less than 3.5 wt %, the crystallinity of the glass obtained therefrom is low, and the coefficient of thermal expansion is also increased considerably. On the other hand, when the content of Li₂O is more than 5.5 wt %, the glass is likely to devitrify due to significantly high crystallinity, thereby transparent crystallized glass is difficult to obtain.

The content of TiO₂ according to the present invention as a nucleation agent is 0.5 to 4.0 wt %, and preferably, 2.3 to 3.5 wt %. When the content of TiO₂ is less than 0.5 wt %, the nucleation rate becomes low. On the other hand, when the content of TiO₂ is more than 4.0 wt %, coloration due to impurities is subject to occur during the production of transparent crystallized glass.

The content of ZrO₂ according to the present invention as a nucleation agent is 0.5 to 3.0 wt %, and preferably, 1.5 to 2.5 wt %. When the content of ZrO₂ is less than 0.5 wt %, the nucleation rate becomes low. On the other hand, when the content of ZrO₂ is more than 3.0 wt %, the glass is strongly devitrified in addition to the melting temperature of the glass becomes too high.

P₂O₅ is a component for improving the meltability of ZrO₂ in addition to preventing devitrification upon the forming of glass, and has a function for controlling crystallization, thereby makes it easier to produce transparent crystallized glass of Li₂O—Al₂O₃—SiO₂ system in which a β-quartz solid solution (Li₂O—Al₂O₃-nSiO₂, n≧2) is produced as a main crystal. The content of P₂O₅ according to the present invention is 0.5 to 3.0 wt %, and preferably, 0.8 to 1.5 wt %. When the content of P₂O₅ is less than 0.5 wt %, the effect of controlling crystallization will cease to function. On the other hand, when the content of P₂O₅ is more than 3.0 wt %, the coefficient of thermal expansion is significantly increased, and the glass is subject to devitrify.

F is a component having a function for controlling crystallization, thereby makes it easier to produce non-transparent crystallized glass of Li₂O—Al₂O₃—SiO₂ system in which a β-spodumene solid solution (Li₂O—Al₂O₃-nSiO₂, n≧4) is produced as a main crystal. The content of F according to the present invention is 0.1 to 1.0 wt %, and preferably, 0.3 to 0.6 wt %. Without the component F, the temperature of the crystallization process in which a β-spodumene solid solution (Li₂O—Al₂O₃-nSiO₂, n≧4) is produced as a main crystal is necessarily to be at a high temperature region which is above 1000° C. However, when F is added thereinto, the temperature of the crystallization process in which a β-spodumene solid solution is produced as a main crystal may just be above 860° C. On the other hand, when the content of F is more than 1.0 wt %, transparent crystallized glass becomes difficult to produce.

B₂O₃ is a component for improving the meltability of raw glass material in addition to decreasing the temperature of melting and molding. The content of B₂O₃ according to the present invention is 0 to 2.5 wt %; when the content of B₂O₃ is 0, it means that B₂O₃ is not added. When the content of B₂O₃ is more than 2.5 wt %, transparent crystallized glass becomes difficult to produce.

Na₂O is a component for improving the meltability of raw glass material. The content of Na₂O according to the present invention is 0 to 2.0 wt %. When the content of Na₂O is more than 2.0 wt %, the coefficient of thermal expansion is subject to increase, which causes the thermal characteristics to deteriorate.

K₂O is a component for improving the meltability of raw glass material. The content of K₂O according to the present invention is 0 to 2.0 wt %. When the content of K₂O is more than 2.0 wt %, the coefficient of thermal expansion is subject to increase, which causes the thermal characteristics to deteriorate.

MgO is a component having a function for improving the meltability of raw glass material and preventing bubble defect from occurring. The content of MgO according to the present invention is 0 to 1.0 wt %. When the content of MgO is more than 1.0 wt %, the coefficient of thermal expansion is subject to increase, which causes the thermal characteristics to deteriorate. Furthermore, when the transparent crystallized glass is produced and there is TiO₂ therein, the glass would have a slight coloration. When the content of MgO is more than the region mentioned above, the coloration becomes intense and the transparency of the glass is likely to be decreased.

ZnO, same as MgO, is a component having a function for improving the meltability of raw glass material and preventing bubble defect from occurring. The content of ZnO according to the present invention is 0.5 to 3.0 wt %. When the content of the ZnO is less than 0.5 wt %, the effect of ZnO mentioned above is not obvious. On the other hand, when the content of ZnO is more than 3.0 wt %, the dielectric loss of the crystallized glass becomes large, wherein the heat concentration phenomenon will occur when the crystallized glass is used for microwave oven purpose or the like. In addition, when transparent crystallized glass is produced, if the content of ZnO is more than the region mentioned above, the coloration due to TiO₂ becomes intense and the transparency of the glass is likely to be decreased.

BaO, same as MgO and ZnO, is a component having a function for improving the meltability of raw glass material and preventing bubble defect from occurring. The content of BaO according to the present invention is 0 to 2.5 wt %. When the content of BaO is more than 2.5 wt %, the coefficient of thermal expansion is subject to increase, the thermal characteristics decreases, and the dielectric loss of the crystallized glass becomes large.

SrO, same as MgO, ZnO, and BaO, is a component having a function for improving the meltability of raw glass material and preventing bubble defect from occurring. The content of SrO according to the present invention is 0.3 to 3.0 wt %. When the content of SrO is less than 0.3 wt %, the effect of SrO mentioned above is not obvious. On the other hand, when the content of SrO is more than 3.0 wt %, the coefficient of thermal expansion is subject to increase, the thermal characteristics decreases, and the dielectric loss of the crystallized glass becomes large.

As₂O₃ functions as a clarity agent, and that is, As₂O₃ generates oxygen during melting state at high temperature, thereby eliminating bubbles in the glass. However, As₂O₃ is highly toxic, and it may pollute the environment during glass manufacturing and disposal. In view of reducing consumption, the content of As₂O₃ according to the present invention is 0.4 to 1.5 wt %. When the content of As₂O₃ is less than 0.4 wt %, the effect of clarity mentioned above is not obvious; on the other hand, when the content of As₂O₃ is more than 1.5 wt %, environmental pollution is more serious.

Sb₂O₃, same as As₂O₃, functions as a clarity agent, and that is, Sb₂O₃ generates oxygen during melting state at high temperature, thereby eliminating bubbles in the glass. Sb₂O₃ also promotes glass crystallization. However, Sb₂O₃ is more likely to induce glass coloration due to impurity than As₂O₃. In view of reducing consumption, the content of Sb₂O₃ is 0 to 1.5 wt %.

In addition, according to the present invention, one or more transition element oxides may be added into the composition of raw glass material as a coloring agent. The at least one transition element may be TiO₂, V₂O₅, Cr₂O₃, MnO₂, Fe₂O₃, Co₂O₃, Co₃O₄, NiO, or CuO.

### EXAMPLE

By comparing comparative examples and examples according to the present invention, the effects and the advantages of the present invention will be descried blow. While the present invention has been described in connection with some examples, it is to be understood that the subject matter encompassed by way of the present invention is not to be limited to those specific examples. These examples are only for exemplifying purpose.

As illustrated in table 1, parameters of the comparative examples including the composition of crystallized glass and the main crystal phase of the same, the temperature and the execution time of crystallization, and the appearance and the coefficient of thermal expansion of crystallized glass, are listed therein. The sample numbers are 1 to 8.

By using the following method, each of the crystallized glass samples 1˜8 of the comparative examples shown in table 1 is produced.

First, raw glass materials in the forms of oxides, hydroxides, halogenated compounds, carbonates, nitrate, and the like were measured so as to form glass having compositions in accordance with those listed in the tables 1. Each glass composition thus prepared was mixed to be homogeneous and was melted in an electric furnace using a platinum crucible at 1,650° C. for 8 to 20 hours.

Subsequently, the molten glass was cast on a surface plate made of carbon and was formed into 5 mm-thick glass sheets by using a roller made of stainless steel. The glass sheets were then cooled to the room temperature by using a slow cooling furnace and become crystallizable glass.

After the crystallizable glass obtained as mentioned above is put into an electric furnace and each sample is crystallized under a heat treatment in different condition, the samples are put into a slow cooling furnace and become crystallized glass.

Sample (1): The temperature and time of the nucleation: 780° C. for 2 hours; the temperature and time of crystal growth: 900° C. for 3 hours.

Sample (2): The temperature and time of the nucleation: 780° C. for 2 hours; the temperature and time of crystal growth: 900° C. for 3 hours.

Sample (3): The temperature and time of the nucleation: 780° C. for 2 hours; the temperature and time of crystal growth: 900° C. for 3 hours.

Sample (4): The temperature and time of the nucleation: 730° C. for 2 hours; the temperature and time of crystal growth: 845° C. for 2 hours.

Sample (5): The temperature and time of the nucleation: 780° C. for 2 hours; the temperature and time of crystal growth: 1160° C. for 1 hours.

Sample (6): The temperature and time of the nucleation: 780° C. for 2 hours; the temperature and time of crystal growth: 1160° C. for 1 hours.

Sample (7): The temperature and time of the nucleation: 780° C. for 2 hours; the temperature and time of crystal growth: 1160° C. for 1 hours.

Sample (8): The temperature and time of the nucleation: 730° C. for 2 hours; the temperature and time of crystal growth: 1100° C. for 2 hours.

The rates of increasing temperature were set to be 300° C./hour from room temperature to the temperature for nucleation and to be 100 to 200° C./hour from the temperature for nucleation to the temperature for crystal growth. The temperature for measuring the coefficient of thermal expansion was set to be 30˜600° C.

TABLE 1

| | Sample number | | | | | | | |
|---|---|---|---|---|---|---|---|---|
| | 1. | 2. | 3. | 4. | 5. | 6. | 7. | 8. |
| SiO₂ | 63.6 | 64.6 | 65.8 | 60.6 | 63.6 | 64.6 | 65.8 | 60.6 |
| Al₂O₃ | 22.0 | 22.0 | 21.1 | 26.0 | 22.0 | 22.0 | 21.1 | 26.0 |
| Li₂O | 4.4 | 4.5 | 4.2 | 5.1 | 4.4 | 4.5 | 4.2 | 5.1 |
| TiO₂ | 1.7 | 0.5 | 1.9 | 2.5 | 1.7 | 0.5 | 1.9 | 2.5 |
| ZrO₂ | 2.1 | 1.8 | 2.3 | 1.3 | 2.1 | 1.8 | 2.3 | 1.3 |
| P₂O₅ | 0.9 | 0.9 | 1.4 | | 0.9 | 0.9 | 1.4 | |
| F | | | | | | | | |
| B₂O₃ | | | | | | | | |
| Na₂O | 0.5 | 0.3 | 0.5 | 0.5 | 0.5 | 0.3 | 0.5 | 0.5 |
| K₂O | 0.6 | 0.6 | 0.3 | 0.8 | 0.6 | 0.6 | 0.3 | 0.8 |
| MgO | | 0.3 | 0.5 | 0.7 | | 0.3 | 0.5 | 0.7 |
| ZnO | 0.4 | 0.4 | 1.0 | | 0.4 | 0.4 | 1.0 | |
| BaO | 3.3 | 3.0 | | 2.0 | 3.3 | 3.0 | | 2.0 |
| As₂O₃ | | 0.4 | 1.0 | 0.5 | | 0.4 | 1.0 | 0.5 |
| Sb₂O₃ | 0.5 | 0.5 | | | 0.5 | 0.5 | | |
| Cl | | 0.2 | | | | 0.2 | | |
| main crystal | β-Q | β-Q | β-Q | β-Q | β-S | β-S | β-S | β-S |
| phase | 900° C./ | 900° C./ | 900° C./ | 845° C./ | 1160° C./ | 1160° C./ | 1160° C./ | 1100° C./ |
| The temperature | 3 hr | 3 hr | 3 hr | 2 hr | 1 hr | 1 hr | 1 hr | 2 hr |
| and time of | | | | | | | | |
| crystal growth | | | | | | | | |
| Appearance | color- | color- | color- | color- | white & | white & | white & | white & |
| | less & | less & | less & | less & | opaque | opaque | opaque | opaque |
| | trans- | trans- | trans- | trans- | | | | |
| | parent | parent | parent | parent | | | | |
| Coefficient of | 1.0 | 1.0 | −3.0 | 5.0 | 17.0 | 14.0 | 11.0 | 18.0 |
| thermal | | | | | | | | |
| expansion | | | | | | | | |
| (×10⁻⁷/° C.) | | | | | | | | |

β-Q: β-quartz
β-S: β-spodumene

As illustrated in table 2, parameters of the examples according to the present invention including the composition of crystallized glass and the main crystal phase of the same, the temperature and the execution time of crystallization, and the appearance and the coefficient of thermal expansion of crystallized glass, are listed therein. The sample numbers are 9 to 16.

By using the following method, each of the crystallized glass samples 9˜16 of the examples according to the present invention shown in table 2 is produced.

First, raw glass materials in the forms of oxides, hydroxides, halogenated compounds, carbonates, nitrate, and the like were measured so as to form glass having compositions in accordance with those listed in the tables 2. Each glass composition thus prepared was mixed to be homogeneous and was melted in an electric furnace using a platinum crucible at 1,600° C. for 8 to 15 hours.

Subsequently, the molten glass was cast on a surface plate made of carbon and was formed into 5 mm-thick glass sheets by using a roller made of stainless steel. The glass sheets were then cooled to the room temperature by using a slow cooling furnace and become crystallizable glass.

After the crystallizable glass obtained as mentioned above is put into an electric furnace and each sample is crystallized under a heat treatment in different condition as listed in table 2, the samples are put into an slow cooling furnace and become crystallized glass.

TABLE 2

| | Sample number | | | | | | | |
|---|---|---|---|---|---|---|---|---|
| | 9. | 10. | 11. | 12. | 13. | 14. | 15. | 16. |
| SiO₂ | 62.5 | 61.6 | 58.5 | 62.5 | 61.3 | 58.5 | 58.5 | 58.5 |
| Al₂O₃ | 21.0 | 21.0 | 23.8 | 21.0 | 21.0 | 23.8 | 24.0 | 24.0 |
| Li₂O | 3.9 | 4.0 | 5.0 | 3.9 | 4.0 | 5.0 | 4.5 | 4.5 |
| TiO₂ | 2.5 | 3.5 | 1.0 | 2.5 | 3.5 | 1.0 | 1.5 | 1.5 |
| ZrO₂ | 2.0 | 1.0 | 3.0 | 2.0 | 1.0 | 3.0 | 2.5 | 2.5 |
| P₂O₅ | 2.2 | 2.0 | 3.0 | 1.7 | 1.5 | 3.0 | 2.0 | 2.0 |
| F | 0.1 | 0.5 | 0.1 | 0.1 | 0.8 | 0.1 | 0.1 | 0.1 |
| B₂O₃ | 1.0 | 2.0 | 0.5 | 1.5 | 2.5 | 0.5 | 1.0 | 1.0 |
| Na₂O | 1.0 | 0.5 | | 1.0 | 0.5 | | 0.5 | 0.5 |
| K₂O | 0.3 | | 1.0 | 0.3 | | 1.0 | 1.0 | 1.0 |
| MgO | 0.2 | 0.2 | 0.7 | 0.2 | 0.2 | 0.7 | 0.7 | 0.7 |
| ZnO | 0.5 | 1.5 | 0.5 | 0.5 | 1.5 | 0.5 | 0.5 | 0.5 |
| BaO | 1.5 | 1.0 | 1.9 | 1.5 | 1.0 | 1.9 | 1.9 | 1.9 |
| SrO | 0.5 | 0.5 | 0.5 | 0.5 | 0.5 | 0.5 | 0.5 | 0.5 |
| As₂O₃ | 0.6 | 0.7 | 0.5 | 0.6 | 0.7 | 0.5 | 0.5 | 0.5 |
| NiO | | | | | | | 0.3 | 0.3 |
| Co₂O₃ | | | | | | | 0.01 | 0.01 |
| Sb₂O₃ | 0.2 | | | 0.2 | | | | |
| main crystal | β-Q | β-Q | β-Q | β-S | β-S | β-S | β-Q | β-S |
| phase | 820° C./ | 800° C./ | 820° C./ | 860° C./ | 870° C./ | 900° C./ | 820° C./ | 880° C./ |
| The | 1 hr | 1 hr | 1 hr | 1 hr | 1 hr | 1 hr | 1 hr | 1 hr |
| temperature | | | | | | | | |
| and time of | | | | | | | | |
| crystal growth | | | | | | | | |
| Appearance | color- | color- | color- | white & | white & | white & | purple | purple & |
| | less & | less & | less & | opaque | opaque | opaque | & trans- | opaque |
| | trans- | trans- | trans- | | | | parent | |
| | parent | parent | parent | | | | | |
| Coefficient of | 1.0 | 2.5 | 3.1 | 13.7 | 11.6 | 15.5 | 3.6 | 16.2 |
| thermal | | | | | | | | |
| expansion | | | | | | | | |
| (×10⁻⁷/° C.) | | | | | | | | |

β-Q: β-quartz
β-S: β-spodumene

Sample (9): The temperature and time of the nucleation: 700° C. for 2 hours; the temperature and time of crystal growth: 820° C. for 1 hours.

Sample (10): The temperature and time of the nucleation: 700° C. for 2 hours; the temperature and time of crystal growth: 800° C. for 1 hours.

Sample (11): The temperature and time of the nucleation: 700° C. for 2 hours; the temperature and time of crystal growth: 820° C. for 1 hours.

Sample (12): The temperature and time of the nucleation: 700° C. for 2 hours; the temperature and time of crystal growth: 860° C. for 1 hours.

Sample (13): The temperature and time of the nucleation: 700° C. for 2 hours; the temperature and time of crystal growth: 870° C. for 1 hours.

Sample (14): The temperature and time of the nucleation: 700° C. for 2 hours; the temperature and time of crystal growth: 900° C. for 1 hours.

Sample (15): The temperature and time of the nucleation: 700° C. for 2 hours; the temperature and time of crystal growth: 820° C. for 1 hours.

Sample (16): The temperature and time of the nucleation: 700° C. for 2 hours; the temperature and time of crystal growth: 880° C. for 2 hours.

The rates of increasing temperature were set to be 300° C./hour from room temperature to the temperature for nucleation and to be 100 to 200° C./hour from the temperature for nucleation to the temperature for crystal growth. The temperature for measuring the coefficient of thermal expansion was set to be 30˜600° C.

A description will be made by comparing comparative examples 1˜8 to the examples 9˜16 according to the present invention. More specifically, the type of main crystals, appearances, coefficients of thermal expansion were measured for the samples 1˜16 thus obtained from comparing comparative examples 1˜8 to the example 9˜16. In addition, “β-Q” and “β-S” in tables 1 and 2 stand for β-quartz solid solution and β-spodumene solid solution, respectively.

In table 1, the temperature of crystal growth is set at a range of 845° C.˜900° C. for comparative examples 1˜4 (samples 1˜4), thereby colorless transparent crystallized glass is obtained in which a β-quartz solid solution is produced as a main crystal.

In table 2, the temperature of crystal growth is set at a range of 800° C.˜820° C. for examples 9˜11 and 15 (samples 9˜11 and 15), thereby colorless and purple transparent crystallized glass is obtained in which a β-quartz solid solution is produced as a main crystal. The coefficients of thermal expansion thereof are close to that of the comparative examples 1˜4 (samples 1˜4), and the glass obtained therefrom has excellent thermal characteristics. As a result, according to the present invention, the colorless and colored transparent crystallized glass can be produced at a lower temperature range of crystal growth.

In table 1, the temperature of crystal growth is set at a range of 1100° C.˜1160° C. for comparative examples 5˜8 (samples 5˜8), thereby white opaque crystallized glass is obtained in which a β-spodumene solid solution is produced as a main crystal.

In table 2, the temperature of crystal growth is set at a range of 860° C.˜900° C. for examples 12˜14 and 16 (samples 12˜14 and 16), thereby white and purple opaque crystallized glass is obtained in which a β-spodumene solid solution is produced as a main crystal. The coefficients of thermal expansion thereof are close to that of comparative examples 5˜8 (samples 5˜8), and the glass obtained therefrom has excellent thermal characteristics. As a result, according to the present invention, the white and purple opaque crystallized glass can be produced at a lower temperature range of crystal growth.

Concluding from above, the present invention provides crystallizable glass of Li₂O—Al₂O₃—SiO₂ system. In addition, the present invention also provides crystallized glass of Li₂O—Al₂O₃—SiO₂ system, which is obtained by treating the crystallizable glass with a crystallization process at a lower temperature range in a crystallization process after the formation of the nucleus of the crystallizable glass and has excellent thermal characteristics and high mechanical strength. According to the present invention, transparent and non-transparent crystallized glass can be obtained by changing the temperature in the crystallization process of the crystallizable glass. According to the present invention, at least one transition element may be added thereinto as a coloring agent, thereby provides transparent and non-transparent crystallized glass of Li₂O—Al₂O₃—SiO₂ system with all kinds of colors.

What is claimed is:

1. A crystallizable glass of Li₂O—Al₂O₃—SiO₂ system which consists essentially of, by weight percentages, SiO₂—58.0˜66.0 wt %; Al₂O₃—18.0˜26.0 wt %; Li₂O—3.5˜5.5 wt %; TiO₂—0.5˜4.0 wt %; ZrO₂—0.5˜3.0 wt %; P₂O₅—0.5˜3.0 wt %; F—0.1˜1.0 wt %; B₂O₃—0˜2.5 wt %; Na₂O—0˜2.0 wt %; K₂O—0˜2.0 wt %; MgO—0˜1.0 wt %; ZnO—0.5˜3.0 wt %; BaO—0˜2.5 wt %; SrO—0.3˜3.0 wt %; As₂O₃—0.4˜1.5 wt %; and Sb₂O₃—0˜1.5 wt %.

2. The crystallizable glass of Li₂O—Al₂O₃—SiO₂ system as described in claim 1, further comprising essentially of at least one transition element.

3. The crystallizable glass of Li₂O—Al₂O₃—SiO₂ system as described in claim 2, wherein the at least one transition element is selected from the group consisting of TiO₂, V₂O₅, Cr₂O₃, MnO₂, Fe₂O₃, Co₂O₃, Co₃O₄, NiO, and CuO. JLINP I 87DIVI/QI 459DIV 15 Application
